(19) United States
(12) Patent Application Publication
(10) Pub. No.: US 2025/0162135 A1
(43) Pub. Date: May 22, 2025

(54) GRIPPING AND/OR CLAMPING DEVICE WITH AN INHIBITING TRANSMISSION

(71) Applicant: SCHUNK SE & Co. KG Spanntechnik Greiftechnik Automatisierungstechnik, Lauffen am Neckar (DE)

(72) Inventors: Michael Gotthardt, Ludwigsburg (DE); Stephan Kilpper, Bietigheim-Bissingen (DE); Tobias Schleusener, Eppingen (DE); Andreas Stanicki, Nordheim (DE)

(21) Appl. No.: 18/949,049

(22) Filed: Nov. 15, 2024

(30) Foreign Application Priority Data
Nov. 20, 2023 (DE) 10 2023 132 197.8

(51) Int. Cl. B25J 9/10

(52) U.S. Cl. CPC B25J 9/102

(57) ABSTRACT

A gripping or clamping device has a base housing having at least one jaw element arranged to be movable in the base housing, and has a transmission unit. The transmission unit has an input shaft and an output shaft. The input shaft couples to a drive and the output shaft couples to the at least one jaw element. The transmission unit is designed as an inhibiting planetary transmission.

### TECHNICAL FIELD

This disclosure relates to a gripping or clamping device having a base housing, having at least one jaw element arranged to be movable in the base housing, and having a transmission unit, wherein the transmission unit has an input shaft and an output shaft, wherein the input shaft can be or is coupled to a drive and wherein the output shaft can be or is coupled to the at least one jaw element.

### BACKGROUND

From EP 190 55 49 B1, a clamping or gripping device with a worm gear is known, wherein the pitch angle of the helical gearing is designed such that, due to a self-inhibition when the drive is not actuated, a position maintenance of the jaw element can be achieved. A worm gear has the disadvantages of poor efficiency, the need for axial adjustment, and bearing requirements due to the high axial forces. From JP 31 56 145 U, a gripping device with a self-inhibiting worm gear is known. This disclosure is therefore based upon the object of providing a gripping or clamping device which eliminates the disadvantages of the prior art; in particular, it ensures reliable position maintenance of the jaw element even when the drive is not actuated.

### SUMMARY

The object upon which the disclosure is based is achieved by a gripping or clamping device having the features of this disclosure. Accordingly, the transmission unit is designed as an inhibiting, in particular partially inhibiting or self-inhibiting, planetary transmission.

Due to the inhibiting planetary transmission, it can be ensured that, even when the drive is not activated, it is not possible to turn the transmission unit back or move the jaw element back (without causing damage). In addition, the planetary transmission has a higher efficiency, a higher power transmission, a more compact design, and a smoother running compared to a worm gear.

For the purposes of the disclosure, an “inhibiting planetary transmission” is understood to mean either a “self-inhibiting planetary transmission” or a “partially inhibiting planetary transmission.” For the purposes of the disclosure, a “self-inhibiting planetary transmission” is understood to mean that a load torque on the actual output, which thereby becomes the drive, can be increased up to a destructive limit without the load torque leading to a movement of the planetary transmission, in particular the input shaft. Increasing the load torque increases, among other things, the counteracting frictional forces. For the purposes of the disclosure, a “partially inhibiting planetary transmission” is understood to mean that the planetary transmission cannot be reversed on the output side up to a limit value of a load torque. The load torque is created by the spring energy stored in the flexibility of the fingers, the workpiece, the drive train, etc.

The following describes the difference between self-inhibition and partial inhibition of a transmission, which is shown in FIG. 4. Using this or a similar approach, the difference between other transmissions, such as a planetary transmission, a coupled planetary transmission, a Wolfrom planetary set, or a spur gear, etc., can also be considered.

For example, a single-stage planetary transmission has a central gear 1, web s, and a central gear 2, wherein the planetary transmission is fixed to the central gear 1 on the housing side. In normal operation, the transmission is driven at the web s and output at the central gear 2. In the opposite direction, the transmission should have a self-inhibiting or partial inhibiting mechanism. This means that the drive is then central gear 2 and the output is the web s. A planetary transmission can have self-inhibition only for one operating mode and only with a positive static ratio. This is achieved, for example, with the planetary transmissions shown in FIG. 4 and FIG. 5. A positive static ratio means that, when the web is stationary, both central wheels rotate in the same direction.

The static transmission ratio for a stationary web s is given by:

$${i}_{12} = \frac{{z}_{p 1}}{{z}_{1}} \cdot \frac{{z}_{2}}{{z}_{p 2}}$$

Load-dependent losses due to tooth friction can be taken into account by an efficiency factor. If the tooth efficiency of the individual stages is known, the static efficiency is calculated as follows:

$${η}_{12} = {η}_{{z}_{1} {z}_{p 1}} \cdot {η}_{{z}_{p 2} {z}_{2}}$$

In addition to the load-dependent losses (e.g., due to tooth friction), there are also load-independent losses, which are shown by a constant torque. This can, for example, be friction from seals or bearings. The constant friction in a transmission is reflected in, among other things, the idle torque.

The web s is therefore preceded by a shaft 0, wherein a constant friction torque is generated independently of the load M_{R} always counter to the direction of rotation of the shaft nₛ=n₀.

With a known static transmission ratio i₁₂ and static efficiency η₁₂=η₂₁, the operating ratio and the operating efficiency for the planetary transmission according to the operating condition with stationary central gear 1 are calculated as follows:

$${i}_{s 2} = \frac{{i}_{12}}{{i}_{12} - 1}$$

$${i}_{2 s} = \frac{1}{{i}_{s 2}} = 1 - \frac{1}{{i}_{12}}$$

For the calculation of the efficiency, it is relevant whether the static transmission ratio is i₁₂>1 or i₁₂<1.

$$Case {i}_{12} < 1 :$$

$$\begin{matrix}{η}_{s 2} = \frac{{i}_{12} - 1}{{i}_{12} - \frac{1}{{η}_{12}}} \\ {η}_{2 s} = \frac{{i}_{12} - {η}_{12}}{{i}_{12} - 1}\end{matrix}$$

$$Case {i}_{12} > 1 :$$

$$\begin{matrix}{η}_{s 2} = \frac{{i}_{12} - {η}_{12}}{{i}_{12} - 1} \\ {η}_{2 s} = \frac{{i}_{12} - \frac{1}{{η}_{12}}}{{i}_{12} - 1}\end{matrix}$$

If η₂ₛ≤0, the transmission is self-inhibiting in the direction from the central gear 2 to the web s. This means that the torque on the central gear 2 (now the drive shaft) leads to internal friction forces that prevent the web s (now the output shaft) from rotating. These forces increase with increasing drive torque and mean that no reverse rotation can occur regardless of the level of drive torque. The torque M₂ can be increased until the transmission or the components thereof are destroyed. If the drive is to be rotated, i.e., if power is to flow from the central wheel 2 to the web s, additional power must be applied to the web s (output shaft). This explains the negative efficiency with which the necessary power can be calculated.

The following relationships apply to driving the shaft 0 to build up a torque for gripping a workpiece:

For a given drive torque M₀ and known constant friction |M_{R}|, the following torque results on the central gear 2 (output shaft):

$${M}_{2} = - ( {M}_{0} ∓ {M}_{R} ) \cdot {i}_{s 2} \cdot {η}_{s 2}$$

The sign of M_{R} results from the direction of rotation and counteracts the direction of rotation of the shaft 0. When the torque is M₀>0, the direction of rotation of the shaft 0 is also positive. Because power P=2·π·n·M is introduced into the transmission, the friction torque M_{R} must be deducted:

$${n}_{0} > 0 \to {M}_{2} = - ( {M}_{0} - {M}_{R} ) \cdot {i}_{s 2} \cdot {η}_{s 2}$$

The following relationships apply to driving the central wheel 2 to relax the tension:

The gripping force or the torque on the central wheel 2 “stored” in the system flexibility leads to a drive of the transmission on the central gear 2 by the gripping force. This corresponds to the operating state in which a torque acts upon the central gear 2 (now the drive shaft). This leads to a reaction torque on shaft 0:

$${M}_{0} = - {M}_{2} \cdot {i}_{2 s} \cdot {η}_{2 s} ∓ {M}_{R}$$

Depending upon the direction of rotation of the shaft 0, the arithmetic sign of M_{R} results. If the direction of rotation is negative because the jaws are opened, the arithmetic sign is negative:

$${n}_{0} < 0 \to {M}_{0} = - {M}_{2} \cdot {i}_{2 s} \cdot {η}_{2 s} - {M}_{R}$$

From the power calculation of P₀=ω₀·M₀=2·π·n₀·M₀, it is calculated whether power is flowing away or whether power has to be added. If a negative torque M₀ occurs in a negative direction of rotation as a result of the calculation, power has to be added. Then, the drive train is not able to relieve the built-up tension and requires additional power from the engine. Thus, the task of “maintaining grip force” is fulfilled in a tension-free state.

The gripping force can be maintained by self-inhibition:

If the efficiency is η₂ₛ<0, there is a self-inhibition in the transmission. Regardless of the torque M₂, it is not possible to turn the transmission from the output side.

If the transmission is to be rotated (or the tension released), on the shaft 0 (now output shaft) a torque of

$${n}_{0} < 0 \to {M}_{0} = - {M}_{2} \cdot {i}_{2 s} \cdot {η}_{2 s} - {M}_{R}$$

must be applied.

The gripping force can be maintained even if the internal friction is greater than the torque M₂:

If the transmission has a positive efficiency η₂ₛ, the torque Mₛ at the web s must be greater than the constant friction M_{R}. The torque conversion through the transmission must be taken into account. Only in this way is the output able to move the transmission:

$${M}_{R} < {M}_{S} = - {M}_{2} \cdot {i}_{2 s} \cdot {η}_{2 s}$$

$$or : {M}_{2} > - \frac{{M}_{R}}{{i}_{S 2} \cdot {η}_{2 S}}$$

As long as the torque on the central wheel 2 is smaller than this limit, the system behaves as required and can maintain the tension itself.

Listed below are numerical examples for a transmission:

$${z}_{1} = - 50 {z}_{p 1} = 16 {z}_{p 2} = 16 {z}_{2} = - 47$$

This results in the static gear ratio:

$${i}_{12} = \frac{- 50}{16} \cdot \frac{16}{- 47} = 0.94$$

This results in the following operational transmission ratios:

$${i}_{s 2} = \frac{{i}_{12}}{{i}_{12} - 1} = \frac{0.94}{0.94 - 1} = - 15.7$$

$${i}_{2 s} = \frac{1}{{i}_{s 2}} = 1 - \frac{1}{{i}_{12}} = 1 - \frac{1}{0.94} = - 0.064$$

It is assumed that there is a constant friction torque |M_{R}|=1 Ncm.

With a static efficiency of 112=0.9, the transmission is self-inhibiting.

The following operating efficiencies result:

$${η}_{s 2} = \frac{{i}_{12} - 1}{{i}_{12} - \frac{1}{{η}_{12}}} = \frac{0.94 - 1}{0.94 - \frac{1}{0.9}} = 0.35$$

$${η}_{2 s} = \frac{{i}_{12} - {η}_{12}}{{i}_{12} - 1} = \frac{0.94 - 0.9}{0.94 - 1} = - 0.67$$

The negative efficiency η₂ₛ makes it clear that it is a self-inhibiting transmission.

A drive torque on shaft 0 (drive shaft) of M₀=10 Ncm results in a torque on the central gear 2 (output shaft) of

$${M}_{2} = - ( {M}_{0} - {M}_{R} ) \cdot {i}_{s 2} \cdot {η}_{s 2} = - ( 10 Ncm - 1 Ncm ) \cdot ( - 15 \text{.7} ) \cdot 0.35 = 49.4 Ncm$$

To release the tension thus applied on the central wheel 2, a torque on the shaft 0 of

$${M}_{0} = - {M}_{2} \cdot {i}_{2 s} \cdot {η}_{2 s} - {M}_{R} = - 49.9 Ncm \cdot ( - 0.0 \; 64 ) \cdot ( - 0.67 ) - 1 N c m = - 3.1 N c m$$

is necessary. A negative torque in conjunction with the negative rotational speed means that additional power must be added to shaft 0 or web s.

With a static efficiency of η₁₂=0.95, the transmission is not self-inhibiting.

The following operating efficiencies result:

$${η}_{s 2} = \frac{{i}_{12} - 1}{{i}_{12} - \frac{1}{{η}_{12}}} = \frac{0 \text{.94} - 1}{0.94 - \frac{1}{0.95}} = 0 \text{.53}$$

$${η}_{2 s} = \frac{{i}_{12} - {η}_{12}}{{i}_{12} - 1} = \frac{0.94 - 0.95}{0.94 - 1} = 0.17$$

Due to the better efficiency, a lower drive torque of M₀=7 Ncm is necessary. This results therefore in a torque on the central gear 2 of

$${M}_{2} = - ( {M}_{0} - {M}_{R} ) \cdot {i}_{s 2} \cdot {η}_{s 2} = - ( 7 N c m - 1 N cm ) \cdot ( - 15 \text{.7} ) \cdot 0.53 = 50 \text{.1} Ncm$$

The torque thus tensioned generates on the web shaft s a torque of

$${M}_{s} = - {M}_{2} \cdot {i}_{2 s} \cdot {η}_{2 s} = - 50.1 Ncm \cdot ( - 0.0 \; 64 ) \cdot 0.17 = 0.5 N c m > 1 N c m = {M}_{R}$$

i.e., the tension cannot be released independently. To release the tension thus applied, a torque on the shaft 0 of

$${M}_{0} = - {M}_{2} \cdot {i}_{2 s} \cdot {η}_{2 s} - {M}_{R} = - 50.1 Ncm \cdot ( - 0.0 \; 64 ) \cdot 0.17 - 1 N c m = - 0.5 N c m$$

is necessary.

Starting at a torque of

$${M}_{2} = - \frac{{M}_{R}}{{i}_{s 2} \cdot {η}_{2 s}} = - \frac{1 Ncm}{- 0.064 \cdot 0.171} = 92 Ncm$$

on central gear 2 (now drive shaft), the transmission spins.

The analytical approach presented here for distinguishing between self-inhibiting and partial inhibiting applies to a single-stage planetary transmission as well as to multi-stage planetary coupling transmission and reduced planetary coupling transmission. In the case of coupled planetary transmissions, the total gear ratio i12 and the overall efficiency in the operating direction η12 and counter to the operating direction η21 must be determined on the basis of the gear train layout.

An advantageous further development provides that the planetary transmission be designed as a single-stage planetary transmission, as a multi-stage planetary coupling transmission, as a reduced planetary coupling transmission, or as a combination of the aforementioned transmissions. It is also possible to combine it with other transmission stages, such as a spur gear or a bevel gear transmission.

Preferably, the planetary transmission is designed to be single-threaded or non-switchable. Preferably, the transmission unit is designed as a single-speed planetary transmission. In a single-speed or non-shiftable transmission, the gear ratio of the transmission is constant, in particular independent of the input torque and/or the output torque.

It is advantageous if a first stage of the planetary transmission is formed by a first partial transmission with a first input member and a first output member, and if a second stage of the planetary transmission is formed by a second partial transmission with a second input member and a second output member. The input shaft is preferably rotationally coupled to the first input member of the first partial transmission, and/or the output shaft is rotationally coupled to the second output member of the second partial transmission. The first output member is preferably rotationally coupled to the second input member. Such interaction of the partial transmissions without intermediate elements results in a space-saving and lightweight transmission unit. Preferably, the input shaft and the output shaft are on one axis.

According to one embodiment, the planetary transmission comprises a first ring gear, a web with one or more planetary gears, and a second ring gear. The planetary gears are designed as stepped planets and have a first side, which engages with the first ring gear, and a second side, which engages with the second ring gear. The web is coupled to the drive of the gripping system. The first ring gear is torsionally rigidly coupled to the base body. The second ring gear represents the output of the planetary transmission and is coupled to the jaws.

A further advantageous embodiment comprises a first ring gear, a web with one or more planetary gears, and a second ring gear. The planetary gears have the same toothing on the first side, which is in engagement with the first ring gear, and on the second side, which is in engagement with the second ring gear. Because the first ring gear and the second ring gear have different numbers of teeth, the same center distance between the ring gears and planetary gears can be achieved by profile shifting of the gears. This design allows a more cost-effective production of the planetary gears. It proves to be advantageous if the ring gears have a number of teeth in the range of 35 to 55 teeth, in particular in the range of 43 to 46 teeth, and the planets have a number of teeth in the range of 10 to 20 teeth, in particular in the range of 12 to 15 teeth.

In this embodiment, it is alternatively advantageous to change only one planet. As the size of the one planet increases, it extends beyond the axis of rotation of the central gears. In this case, we speak of an eccentric or Akbar transmission. The planet can be designed as a stepped planet or with continuous toothing.

According to a preferred embodiment, the transmission can also be designed as a reduced planetary coupling transmission. A first sun gear, which engages with one or more planetary gears, is used as the input element. A planet carrier can be used for the planetary gears. Because no power is transmitted thereby, it is not necessary and can be omitted for cost reasons. The planetary gears engage with two ring gears. A first ring gear is fixed to the base body, and the second ring gear represents the output. It is advantageous if the planetary gears have a consistent, identical toothing, and the difference in the number of teeth of the ring gears is realized by different profile shifts. However, it is also conceivable that the planetary gears have two different sets of teeth, of which the one engages with the first ring gear and the second with the second ring gear. Such an arrangement is also called a Wolfrom transmission. It proves to be advantageous if the ring gears have a number of teeth in the range of 35 to 55 teeth, in particular in the range of 43 to 46 teeth, and/or the planets have a number of teeth in the range of 10 to 20 teeth, in particular in the range of 12 to 15 teeth, and/or the sun has a number of teeth in the range of 12 to 25 teeth, in particular in the range of 14 to 20 teeth. This preferred embodiment has the advantage of providing a higher overall gear ratio with fewer components and less installation space. This increases the power density, resulting in a smaller end product. This meets the requirements of self-inhibition, which is always a challenge, especially with small transmissions.

The transmission unit is preferably arranged in the base housing and/or in an attachment housing.

According to a further embodiment, the first partial transmission could comprise a first planet carrier, at least one first planetary gear arranged on the first planet carrier, and a first ring gear and a second ring gear. It is conceivable that the first input element be formed by the first planet carrier. It is also conceivable that the first output element be formed by the second ring gear. Preferably, the first planetary gear has two different sets of teeth. The second partial transmission could comprise a second sun gear, a second planet carrier, at least one second planetary gear arranged on the second planet carrier, and a third ring gear. The second input element could be formed by the second sun gear. The second output element could be formed by the third ring gear. It is further advantageous if the base housing forms and/or fixes the first ring gear and the second planet carrier. In this case, the first ring gear and the second planet carrier are fixed relative to the base housing.

An advantageous further development provides that the gripping or clamping device for maintaining the gripping force have a gripping force maintenance means on at least one jaw element. Accordingly, position maintenance can be achieved by means of the inhibiting planetary transmission, and gripping force maintenance can be achieved by means of the gripping force maintenance device. The interaction of the inhibiting planetary transmission and the gripping force maintenance device represents an optimal fallback position in the event of a drive failure. It is advantageous if, in addition to the gripping force maintenance means, a position maintenance means is also provided, in particular in the form of a brake and/or a clamping/inhibiting mechanism.

The gripping force maintenance means is preferably designed as a spring means, in particular as an arc spring clutch. The arc spring clutch preferably couples the input shaft and the output shaft, wherein in particular the power transmission takes place from the input shaft via the arc spring clutch to the output shaft. The arc spring clutch preferably extends along a transmission axis and/or is preferably arranged along the transmission axis between the input shaft and the output shaft of the inhibiting planetary transmission. For this purpose, the input shaft and/or the output shaft and/or the arc spring clutch can be arranged coaxially with the transmission axis. The arc spring clutch is preferably rotatably mounted in the base housing or in the attachment housing. Alternatively, it is conceivable that the input shaft and the output shaft be arranged offset from one another perpendicular to the transmission axis. In this case, the arc spring clutch can be arranged coaxially with the input shaft or the output shaft, or can also be arranged perpendicular to the transmission axis offset from the input shaft and the output shaft. In all arrangements, the power transmission between the input shaft and the output shaft preferably takes place via the at least one arc spring clutch.

This is accompanied by the advantages that, due to the flexibility introduced into the drive train by the arc spring clutch, a gripping force can be maintained with as little loss as possible, and that the pulse forces or pulse force peaks that damage the clamping or gripping device are reduced by means of the arc spring clutch. Maintaining gripping force with as little loss as possible means that at least 70%, in particular at least 80%, preferably at least 90%, preferably at least 95%, of the gripping force introduced by the drive is maintained, and the drop in gripping force is only very slight.

As an alternative to the arc spring clutch, a claw clutch with damping, clastic gear rims, a clutch with compression or tension springs, a clutch with spiral springs, or a clutch with a leg spring can also be used as a gripping force maintenance device and/or as a clutch.

Compared to a claw clutch with elastic plastic elements, the arc spring clutch has a linear behavior, greater flexibility, higher fatigue strength with the same flexibility, less wear, and a lesser impact of temperature and humidity on the behavior and aging. Compared to a clutch with straight compression or tension springs, the arc springs allow a larger angle of rotation in the same installation space. Compared to a clutch with spiral springs, higher spring rates can be achieved in the same installation space. Compared to a clutch with leg springs, less axial space is required. Consequently, a higher power density is possible.

An advantageous embodiment of the disclosure provides that the arc spring clutch have a lower shell rotatably mounted in the base housing or in the attachment housing (both hereafter referred to as housing), an upper shell formed separately from the lower shell, and at least one arc spring. The arc spring can alternatively be replaced by a straight helical compression spring, which is deformed into an arc shape by being installed in the lower shell and/or the upper shell. The lower shell and the upper shell can preferably be rotated relative to one another when assembled. The lower shell is rotatably mounted in the housing and/or in the upper shell. The upper shell is rotatably mounted in the housing and/or in the lower shell. A relative rotational movement between the lower shell and the upper shell results in a compression of at least one arc spring. Such a structure represents an arc spring clutch that is easy and quick to manufacture and assemble. The arc spring absorbs damaging pulse forces and, thanks to its high degree of flexibility, allows gripping force to be maintained with as little loss as possible in terms of settling behavior during gripping and backlash in the drive train. In this way, when gripping a clamped workpiece which realigns itself after the original clamping between the gripping jaws is released, the gripping force can be maintained with as little loss as possible, and loss of the workpiece can be prevented. The prior art solution of a permanently powered drive or “post-energization” is therefore superfluous. In conjunction with, for example, a self-inhibiting transmission, the gripper drive can be switched off when the workpiece is being transported.

It is advantageous if the lower shell has in particular a circular ring-shaped bearing inner ring and in particular a circular ring-shaped bearing outer ring. The bearing inner ring is preferably arranged radially inwards relative to the transmission axis and/or the bearing outer ring in the assembled state, and/or the bearing outer ring is preferably arranged radially outwards relative to the transmission axis and/or the bearing inner ring in the assembled state. Furthermore, the lower shell preferably has a shell base on which the bearing inner ring and the bearing outer ring arc arranged. The bearing inner ring and the bearing outer ring preferably protrude parallel to the transmission axis relative to the shell base when assembled.

The bearing inner ring and the bearing outer ring, and in particular the shell bottom, preferably delimit a spring receptacle, in particular partial circular ring-shaped or in particular annular ring-shaped, for receiving the at least one arc spring. The arc spring is preferably arranged in the spring holder and/or radially to the transmission axis between the bearing inner ring and the bearing outer ring. The spring holder provides a secure mounting of the arc spring in the arc spring clutch, particularly in the lower shell, so that the arc spring cannot hit an interfering contour during compression or re-deformation, or rub against the transmission housing, which sometimes rotates quickly relative to the arc spring.

The arc spring preferably extends along a spring axis, wherein the spring axis extends along the circumference of a circle or partial circle.

It is further advantageous if the lower shell has at least one drive web which interacts with the at least one arc spring in such a way that the arc spring can be rotated about the transmission axis by means of the at least one drive web. The rotation of the lower shell preferably causes a rotation of the arc spring.

Preferably, the upper shell has at least one clutch web. Furthermore, the upper shell preferably has a shell lid. The clutch web is preferably arranged on the shell cover and/or protrudes parallel to the transmission axis relative to the shell cover when mounted. The at least one clutch web interacts with the arc spring in such a way that the upper shell can be driven by means of the lower shell and/or the at least one arc spring. The rotation of the lower shell therefore preferably causes a rotation of the arc spring and also a rotation of the upper shell if no opposing torque acts upon the upper shell. When the lower shell is rotated and the upper shell is locked, e.g., by an object gripped between the jaws, at least one arc spring is compressed by means of the drive web and the clutch web.

A further advantageous development of the disclosure provides that at least one inner drive web be arranged on the bearing inner ring and an outer drive web be arranged on the bearing outer ring. The inner drive web and/or the outer drive web preferably extends into the spring receptacle. The inner drive web and/or the outer drive web preferably face one another and/or are arranged at the same angular position relative to the transmission axis in the assembled state and in the spring-unloaded state of the arc spring. Preferably, in the assembled and spring-unloaded state, the at least one clutch web is in a space between the inner drive web and the outer drive web. This preferably also applies when the arc spring is loaded by preloading. The clutch web preferably intersects the spring axis of the at least one arc spring. The provision of an inner drive web and an outer drive web ensures secure mounting of the arc spring in the spring holder. Furthermore, the clutch web engages centrally on the arc spring. This ensures a homogeneous flow of force during power transmission between the lower shell and the arc spring as well as between the arc spring and the upper shell.

Alternatively, it is conceivable that the upper shell have the bearing inner ring, the bearing outer ring, and the drive webs, and the lower shell have the clutch webs, wherein the at least one arc spring is arranged in a spring receptacle of the upper shell.

A further advantageous embodiment of the disclosure provides that the arc spring clutch have two arc springs. The lower shell preferably provides two pairs of an inner drive web and an outer drive web. Furthermore, the upper shell preferably has two clutch webs. Consequently, a pair of drive webs and a clutch web are arranged between the two arc springs. The pair of drive webs and/or the clutch webs form an angle of between 160° and 200°, in particular between 170° and 190°, preferably 180°, with respect to the transmission axis. This is the case, for example, if the two arc springs have the same spring length. Especially when smaller angles of rotation are to be realized, it can be useful to provide one drive web and one clutch web per spring, which can then be arranged at angles smaller than 180° to one another.

It is advantageous if the lower shell is sleeve-shaped and/or has a central opening. Furthermore, it is advantageous if the upper shell has a pin that protrudes in particular from the shell lid and/or the drive web. Preferably, the pin engages in the central opening of the lower shell when assembled. Furthermore, it is advantageous if the pin is hollow and can therefore accommodate a drive or transmission element. As a result, the drive unit can be built axially flatter. The cavity in the upper shell and/or in the lower shell and/or the pin can also be designed as a grease reservoir.

It is further advantageous if the arc spring clutch, in particular the lower shell and/or the upper shell, is rotatably mounted in the housing in a sliding manner. This results in simple and low-maintenance accommodation of the arc spring clutch.

Preferably, the upper shell and the output shaft are coupled to one another in a torsionally rigid manner. Accordingly, a rotation of the upper shell immediately causes a rotation of the output shaft. The jaws are then moved so that an object can be gripped with the clamping or gripping device. Preferably, the arc spring clutch is arranged between the second output member of the second partial transmission and the output shaft.

It is also advantageous if the lower shell is torsionally rigidly coupled to the second output member of the second partial transmission.

Magnetic, hydraulic, or pneumatic brakes and/or friction means and/or clamping means and/or elastomer means can also be used as alternative gripping force maintenance means.

The gripping force maintenance means can preferably have a translational elasticity means and a separately designed rotational elasticity means. The elasticity means can be designed as spring means and/or elastomer means. This means that the inevitably occurring transmission and clutch play as well as system-inherent flexibility can be compensated for by means of adjustable elasticity in the drive train, thereby generating a controlled gripping force maintenance. A spring means, in particular an arc spring, and/or an elastomer means can be provided as the rotational elasticity means. A spring means and/or an elastomer means can be provided as the translational elasticity means. The translational elasticity means and the rotational elasticity means are preferably arranged at a distance from one another. Preferably, the translational elasticity means is arranged in a guide assembly of the synchronization pinion and/or the rack of the jaws.

Due to the properties or a targeted design of the elastic/spring elements, kinetic energy in the drive train can be dissipated to a greater extent. This allows the gripping pulse generated during operation, which can be higher than the original gripping force, to be limited to a previously defined range. Through a targeted design of the elasticities in the system, kinetic energy is converted into spring energy. If a workpiece is lost, the elasticity (the mechanical spring) relaxes, causing the base jaw to move in the axial direction. This movement is preferably detected by a position measuring system and can be used to detect workpiece loss in the gripper control system.

In a first embodiment, the rotational elasticity means is designed as an arc spring, and the translational elasticity means is designed as a mechanical spring, in particular made of plastic or metal. Due to the combination of two adjustable, additive elasticities, the force curve can be influenced by means of two different possibilities of maintaining gripping force over a wide range. Accordingly, the adaptability and behavior of the mechatronic gripper is significantly improved. In addition, larger spring travels can be realized, which allows gripping pulse reduction and workpiece loss detection. Furthermore, by specifically adjusting the properties of the spring elements, the force curve (operating point) can be changed over a larger range.

In a second embodiment, a translational elasticity means is provided in the form of an elastomer element, in particular made of plastic or metal, and no rotational elasticity means is provided. Compared to the first embodiment, there is less possibility of adjusting the elasticity, because only an elasticity means that maintains grip force is used. This brings with it the advantages of a compact design, simplified interchangeability and assembly of the gripping force maintenance device.

In a third embodiment, a translational elasticity means is provided in the form of a mechanical spring, in particular made of plastic or metal, and no rotational elasticity means is provided. Compared to the first embodiment, there is less possibility of adjusting the elasticity, because only an elasticity means that maintains grip force is used. This has the advantage that larger spring travels can be realized, which allows gripping pulse reduction and workpiece loss detection.

In a fourth embodiment, a translational elasticity means in the form of an elastomer element, in particular made of plastic or metal, and a rotational elasticity means in the form of an arc spring are provided. This allows the gripping pulse generated during operation, which can be higher than the original gripping force, to be limited to a previously defined range. Through a targeted design of the elasticities in the system, kinetic energy is converted into spring energy. If a workpiece is lost, the elasticity (the mechanical spring) relaxes, causing the base jaw to move in the axial direction. This movement is preferably detected by a position measuring system and can be used to detect workpiece loss in the gripper control system. Furthermore, the gripping force maintenance means can be provided more easily and at a lower cost compared to the first embodiment.

It is advantageous if the gripping or clamping device has a drive. An inhibiting planetary transmission in a gripping or clamping device allows a compact device and at the same time high gripping or clamping forces. The drive can be smaller and lighter than usual, which in turn saves space and weight. Low weight and a drive with reduced energy requirements mean that industrial and assembly plants can be made more efficient. Furthermore, automatic switching eliminates the need for control cables, external mechanics, and/or electronics, thus reducing complexity.

It is further advantageous if the gripping or clamping device has an attachment housing which is designed separately from the base housing and in which the drive and/or the inhibiting planetary transmission are arranged. If the inhibiting planetary transmission is arranged in the attachment housing, the statements regarding forming or fixing the transmission component of the first and second transmission stages also apply accordingly to the attachment housing. Alternatively, the drive is arranged in the attachment housing and the inhibiting planetary transmission in the base housing.

The object upon which the disclosure is based is also achieved by a transmission assembly for a gripping or clamping device, wherein the transmission assembly has a described transmission unit, in particular having one or more of the aforementioned features, and an arc spring clutch, in particular having one or more of the aforementioned features.

### BRIEF DESCRIPTION OF THE DRAWINGS

Further details and advantageous embodiments of the disclosure can be found in the following description, by which exemplary embodiments of the disclosure are further described and explained.

In the drawings:

FIG. 1 is a sectional view of a gripping or clamping device with a self-inhibiting planetary transmission and an arc spring clutch;

FIG. 2 is a sectional view of the planetary transmission according to FIG. 1;

FIG. 3 is a perspectival bottom view of the planetary transmission according to FIG. 2;

FIGS. 4 to 8 show gear train layouts for a planetary transmission in different embodiments;

FIG. 9 is a schematic top view of the arc spring clutch according to FIG. 1;

FIG. 10 is a schematic bottom view of the arc spring clutch according to FIG. 9;

FIG. 11 is a side sectional view of the arc spring clutch according to FIG. 9;

FIG. 12 is a top sectional view of the arc spring clutch according to FIG. 9; and

FIGS. 13-16 are sectional views of the gripping or clamping device according to FIG. 1 with different embodiments of gripping force maintenance means.

### DETAILED DESCRIPTION

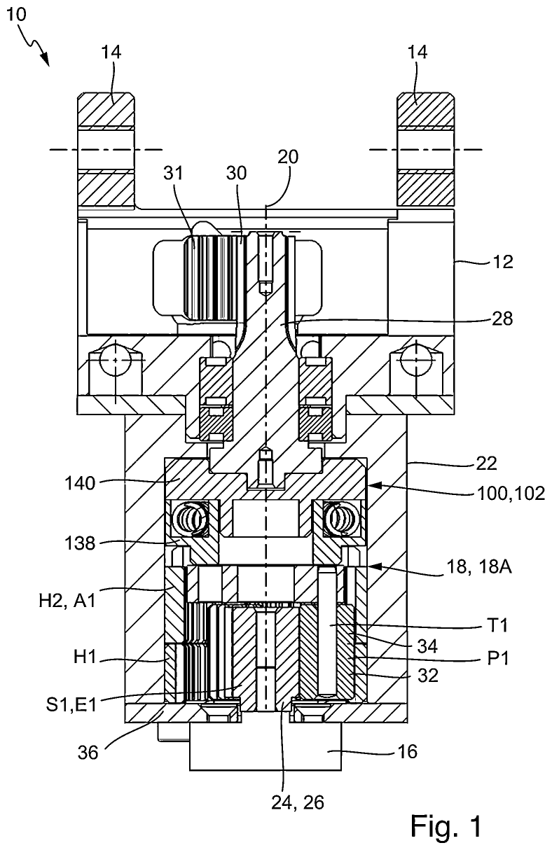

FIG. 1 shows a clamping and/or gripping device 10 for gripping an object (not shown) with two jaw elements 14 that can be moved linearly between a closed position and an open position in a base housing 12.

To drive the jaw elements 14, the clamping and/or gripping device 10 has a drive 16, wherein the drive 16 can be electrical, pneumatic, or manual, for example. Arranged between the drive 16 and the jaw elements 14 is a transmission unit 18 which is designed as a self-inhibiting planetary transmission 18A and extends along a transmission axis 20. The transmission unit 18 is arranged in an attachment housing 22, wherein the attachment housing 22 is preferably flanged to the base housing 12. Alternatively, it is conceivable that the transmission unit 18 be arranged in the base housing 12. The drive 16 is arranged on the attachment housing 22 in FIG. 1. Alternatively, the drive 16 can also be arranged in the attachment housing 22 or in the base housing 12.

According to FIG. 1, the transmission unit 18 has an input shaft 24 which extends along the transmission axis 20 and is rotatably mounted in the attachment housing 22 and is motion-coupled to a drive shaft 26 of the drive 16. Alternatively, the drive shaft 26 of the drive 16 forms the input shaft 24. The transmission unit 18 further has an output shaft 28 extending along the transmission axis 20 and rotatably mounted in the base housing 12 and/or in the attachment housing 22, and which is motion-coupled to the jaw elements 14 by means of a synchronization pinion 30. The synchronization pinion 30 interacts with rack profiles 31 provided on the jaw elements 14. As soon as the input shaft 24 is set in a rotary motion, the output shaft 28 rotates synchronously in the same direction of rotation. The output shaft 28 is coupled to the synchronization pinion 30 and thus sets the jaw elements 14 in motion.

The input shaft 24 and the output shaft 28 rotate at different speeds. Depending upon the number of teeth, the input shaft 24 and the output shaft 28 rotate in the same or opposite direction of rotation with respect to the transmission axis 20. The input torque DE is multiplied by the transmission unit 18, so that the jaw elements 14 can be moved with an increased force by an output torque DA that is increased compared to the input torque DE. The direction of rotation can be clockwise or counterclockwise.

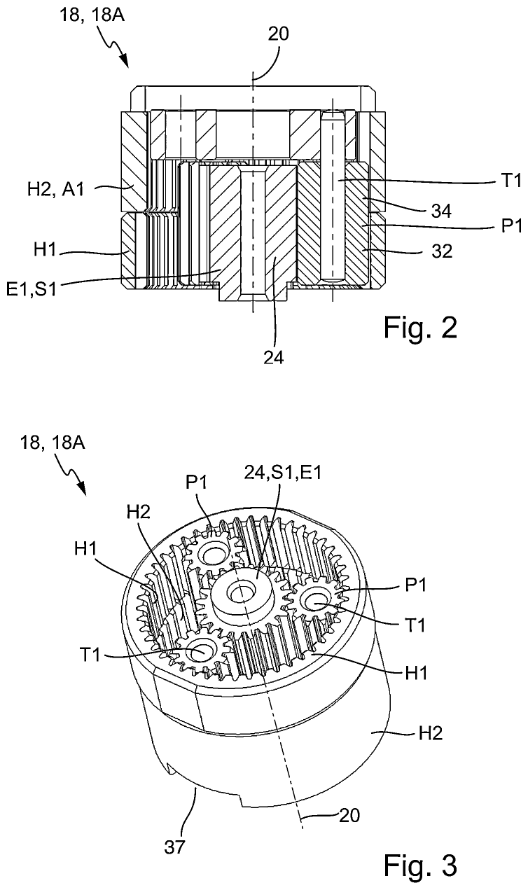

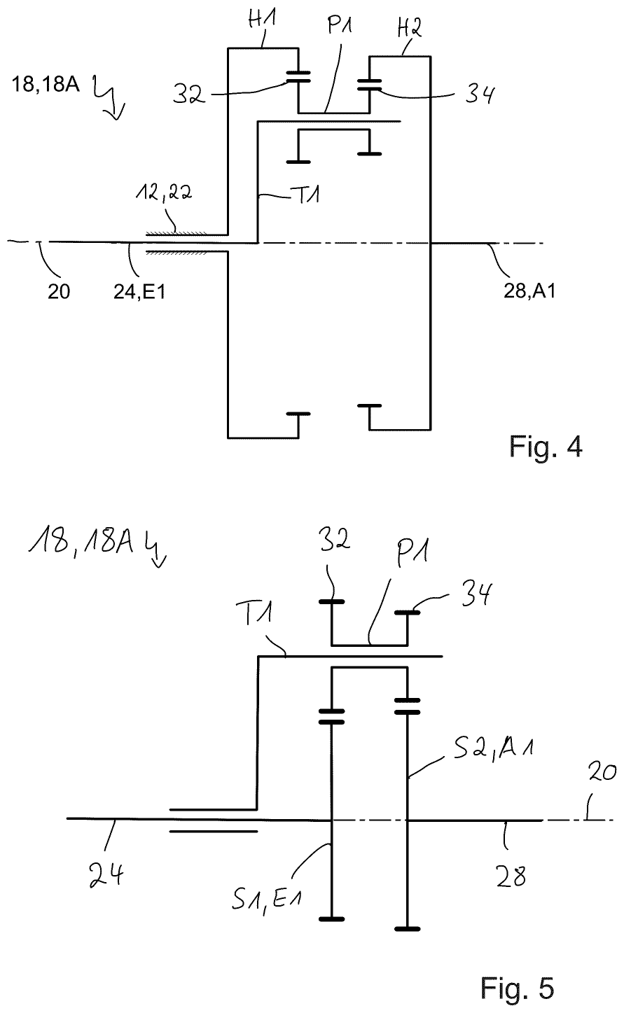

In FIGS. 1 to 3, it can be seen that the transmission unit 18 comprises a first ring gear H1, a sun gear S1, first planetary gears P1 arranged on a first planet carrier T1, and a second ring gear H2. The first sun gear S1 is connected to the input shaft 24 and forms a first input element E1. Preferably, three planetary gears P1 are provided; however, another number is also conceivable. The planetary gears P1 each have a first planetary portion 32 and a second planetary portion 34, which are designed identically in this embodiment; however, different numbers of teeth and/or diameters are conceivable for the planetary portions 32, 34. The first planetary portion 32 is in engagement with the ring gear H1, and the second planetary portion 34 is in engagement with the second ring gear H2. The second ring gear H2 forms the first output member A1 and is coupled to the output shaft 28 via an arc spring clutch 102. The first ring gear H1 is rotationally fixedly coupled to the base housing 12 and/or the attachment housing 22. It is also conceivable that the base housing 12 and/or the attachment housing 22 form the first ring gear H1. The attachment housing 22 is closed by a housing cover 36, which is screwed to the attachment housing 22. The first planet carrier T1 is preferably rotatably arranged on the housing cover 36, whereby it can rotate about the transmission axis 20 independently of the housing cover 36. For this purpose, a bearing can be provided between the housing cover 36 and the first planet carrier T1.

At least one component of the transmission unit 18 is fixed, so that the input torque DE is converted into a higher output torque DA. Relative movements occur between the individual components of the transmission unit 18. In the embodiment according to FIGS. 1 to 3, the first ring gear H1 is rotationally fixed relative to the attachment housing 22.

When the first ring gear H1 is connected to the attachment housing 22 in a rotationally fixed manner, the components of the transmission unit 18 move as follows:

The first sun gear S1 is driven by the input shaft 24; thereby, the planetary gears P1 are driven and run on the fixed first ring gear H1 with the first planetary portion 32. The planetary gears P1 rotate about their respective axes and perform a circular movement about the transmission axis 20. As a result, the second ring gear H2 is driven with the second portion 34. The second ring gear H2 therefore rotates very slowly counter to the direction of rotation of the input shaft 24 with a high torque. The second ring gear H2 preferably drives the output shaft 28 or a subsequent drive element.

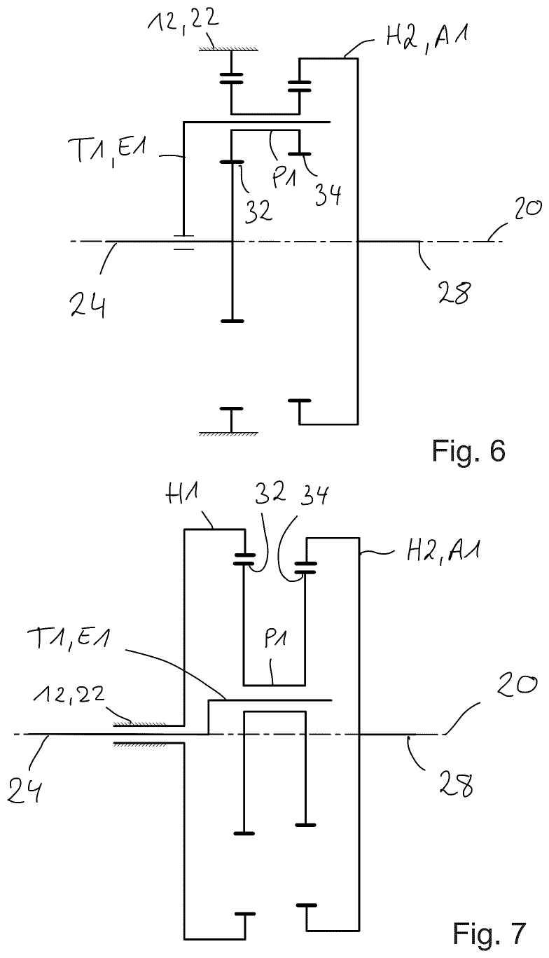

In FIG. 4, a transmission diagram of another embodiment of the planetary transmission 18A is shown. It is a single-stage planetary transmission 18A with a positive static ratio and ring gears as central gears. The planetary transmission 18A comprises a first ring gear H1, a first planet carrier T1 with one or more planetary gears P1, and a second ring gear H2. The planetary gears P1 are designed as stepped planets and have a first planetary portion 32, which engages with the first ring gear H1, and a second planetary portion 34, which engages with the second ring gear H2. The planet carrier T1 is coupled to the input shaft 24. The first ring gear 24 is torsionally rigidly coupled to the base housing 12 and/or the attachment housing 22. The second ring gear H2 represents the output of the planetary transmission 18A and is coupled to the output shaft 28.

A transmission diagram of a further embodiment of the planetary transmission 18A is shown in FIG. 5. This is a single-stage planetary transmission 18A with a positive static ratio and externally toothed spur gears as central gears. The planetary transmission 18A comprises a first sun gear S1, a first planet carrier T1 with one or more planetary gears P1, and a second sun gear S2. The planetary gears P1 are designed as stepped planets and have a first planetary portion 32, which engages with the first sun gear S1, and a second planetary portion 34, which engages with the second sun gear S2. The sun gear is coupled to the input shaft 24. The second sun gear S2 represents the output of the planetary transmission 18A and is coupled to the output shaft 28.

In FIG. 6, a transmission diagram of the embodiment of the planetary transmission 18A according to FIG. 1 is shown. This is a single-stage planetary transmission 18A with a positive static ratio and two ring gears as central gears or a reduced planetary coupling transmission (Wolfrom transmission). The planetary transmission 18A comprises a sun gear S1, which is coupled to a planet carrier T1. On the planet carrier T1, there are one or more planetary gears P1. Furthermore, a second ring gear H2 is provided. The planetary gears P1 have a first planetary portion 32, which engages with the first ring gear H1, and a second planetary portion 34, which engages with the second ring gear H2, wherein the planetary portions 32, 34 have the same toothing throughout. Because the first ring gear H1 and the second ring gear H2 have different numbers of teeth, the same center distance between the ring gears H1, H2 and the planetary gears P1 can be achieved by shifting the profile of the gears. It is also conceivable that the planetary gears P1 have two different sets of teeth, of which the one engages with the first ring gear H1 and the second with the second ring gear H2. Such an arrangement is also called a Wolfrom transmission. It proves to be advantageous if the ring gears H1, H2 have a number of teeth in the range of 35 to 55 teeth, in particular in the range of 43 to 46 teeth, and/or the planetary gears P1 have a number of teeth in the range of 10 to 20 teeth, in particular in the range of 12 to 15 teeth, and/or the sun gear S1 has a number of teeth in the range of 12 to 25 teeth, in particular in the range of 14 to 20 teeth. This preferred embodiment has the advantage of providing a higher overall gear ratio with fewer components and less installation space. This increases the power density, resulting in a smaller end product. This meets the requirements of self-inhibition, which is always a challenge, especially with small transmissions.

Another embodiment of a planetary transmission 18A comprises a first ring gear H1, a planet carrier T1 having one or more planetary gears P1, and a second ring gear H2. The planetary gears P1 have a first planetary portion 32, which engages with the first ring gear H1, and a second planetary portion 34, which engages with the second ring gear H2, wherein the planetary portions 32, 34 have the same toothing. Because the first ring gear H1 and the second ring gear H2 have different numbers of teeth, the same center distance between the ring gears H1, H2 and the planetary gears P1 can be achieved by shifting the profile of the gears. This embodiment allows a more cost-effective production of the planetary gears P1. It proves to be advantageous if the ring gears H1, H2 have a number of teeth in the range of 35 to 55 teeth, in particular in the range of 43 to 46 teeth, and the planetary gears P1 have a number of teeth in the range of 10 to 20 teeth, in particular in the range of 12 to 15 teeth.

In FIG. 7, a further advantageous modification of the embodiment is shown, wherein preferably only one planetary gear P1 is used. As the size of one planetary gear P1 increases, it extends beyond the rotation axis 20 of the central gears. In this case, we speak of an eccentric or Akbar transmission. The planetary gear P1 can be designed as a stepped planet or with continuous toothing. This results in a larger gear ratio compared to the embodiment shown in FIG. 6.

In FIG. 8, a further advantageous embodiment of the transmission unit 18 with a first partial transmission G1 and a second partial transmission G2 is shown as a gear train layout. The first partial transmission G1 comprises a first planet carrier T1, at least one first planetary gear P1, a first ring gear H1, and a second ring gear H2. The first partial transmission G1 does not include a first sun gear. The second partial transmission G2 comprises a second planet carrier T2, at least one second planetary gear P2, a second sun gear S2, and a third ring gear H3. The first planet carrier T1 forms a first input member E1 and is coupled to the input shaft 24. The second ring gear H2 forms a first output element A1 and is coupled to the second sun gear S2. The sun gear S2 forms a second input element E2 of the second partial transmission G2. The third ring gear H3 forms the second output element A2 and can be coupled to the output shaft 28. The first planetary gear P1 has a first planetary portion 32 and a second planetary portion 34, wherein the first planetary portion 32 cooperates with the first ring gear H1, and the second planetary portion 34 cooperates with the second ring gear H2. The planetary portions 32, 34 are shown differently, but can be designed identically, which is made possible by a suitable choice of the number of teeth and profile shifts of the corresponding components H1, H2 and P1. The first ring gear H1 and the second planet carrier T2 are preferably fixed relative to the base housing 12 and/or the attachment housing 22. This results in a larger gear ratio compared to the embodiment shown in FIG. 6.

All embodiments of the transmission unit 18 have in common that the input shaft 24 and the output shaft 28 run along the transmission axis 20; they can be hollow in order to guide through sensor cables or other supply lines.

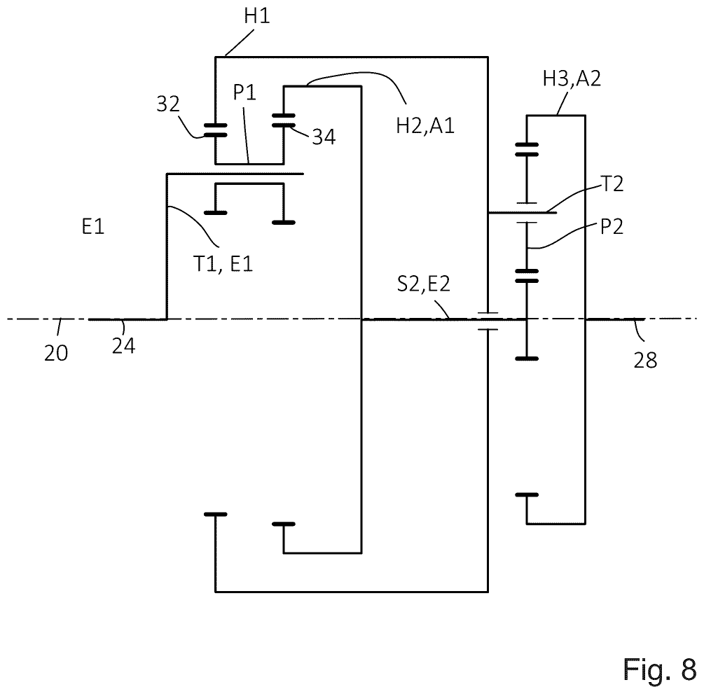

According to FIG. 1, the gripping or clamping device 10 further has a gripping force maintenance means 100. The gripping force maintenance means 100 is designed as an arc spring clutch 102 according to FIGS. 9 to 12. By means of the gripping force maintenance means 100, a gripping force maintenance on the jaw elements 14 can be realized. The combination of the self-inhibiting planetary transmission 18A in conjunction with the arc spring clutch 102 is accompanied by the advantages that, due to the flexibility introduced into the drive train by means of the arc spring clutch 102 and the non-reversibility of the self-inhibiting planetary transmission 18A, a gripping force can be maintained with as little loss as possible, and that pulse forces or pulse force peaks damaging the clamping or gripping device 10 are reduced by means of the arc spring clutch 102.

The arc spring clutch 102 is preferably arranged between the second output member A2 and the output shaft 24, wherein the second output member A2 is rotationally coupled to the arc spring clutch 102.

According to FIGS. 9 to 12, the arc spring clutch 102 has a lower shell 138 and an upper shell 140, wherein the lower shell 138 and the upper shell 140 are coupled to one another by means of two arc springs 142. The lower shell 138 is rotationally coupled to the second output element A2. The upper shell 140 is rotationally coupled to the output shaft 28.

When the second ring gear H2 forms the second output member, the second ring gear H2 is rotationally coupled to the arc spring clutch 102. For this purpose, the lower shell 138 has two lugs 139 that face the planetary transmission 18 and which, in the assembled state, engage in two recesses 37, facing the arc spring clutch 30, of the second ring gear H2. The same applies to the other transmission variants, wherein the recesses are arranged on the sun gear, on the planetary gears, or on the planet carrier.

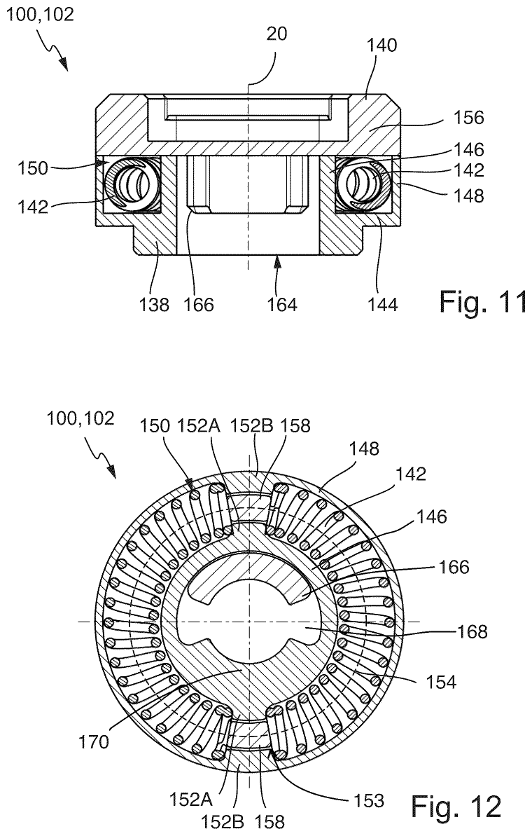

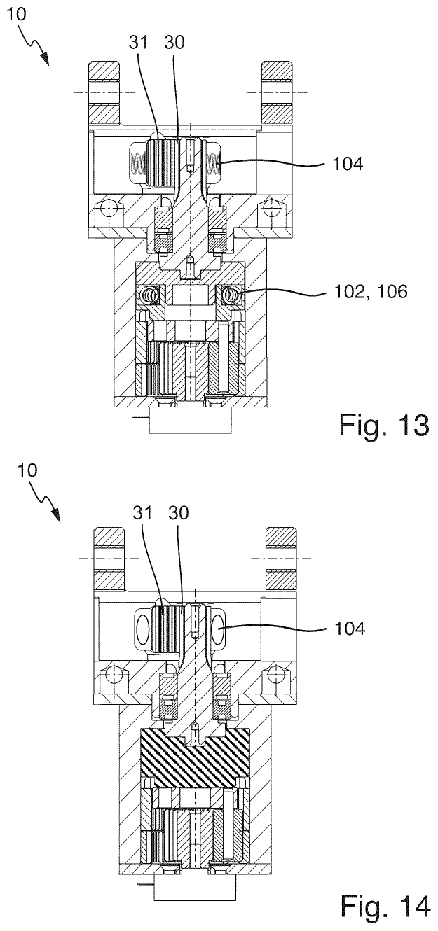

According to FIGS. 11 and 12, the lower shell 138 has a shell bottom 144, a circular bearing inner ring 146, and a circular bearing outer ring 148, which together define a partial circular ring-shaped spring holder 150 for receiving the arc springs 142. In addition, according to FIG. 12, an inner drive web 152A is provided on the bearing inner ring 146 and an outer drive web 152B is provided on the bearing outer ring 148, spaced at an angle of 180° from one another. The bearing inner ring 146, the bearing outer ring 148, and the drive webs 152A, 152B protrude parallel to the transmission axis 20 relative to the shell bottom 144.

According to FIG. 12, the arc springs 142 each extend along a spring axis 154, which runs along a circular circumference or a partial circular circumference around the transmission axis 20. The arc springs 142 are arranged in the spring holder 150, are slightly preloaded, and are supported on the inner drive webs 152A and the outer drive webs 152B. The arc springs 142 reduce the force pulses or force peaks and, due to their flexibility, also ensure that the force is maintained at the jaw elements 14 with almost no loss.

According to FIGS. 11 and 12, the upper shell 140 has a shell cover 156 and two clutch webs 158, wherein the clutch webs 158 are spaced apart at an angle of 180°. The shell cover 156 closes the spring holder 150. The clutch webs 158 are each arranged radially between the inner drive web 152A and the outer drive web 152B with respect to the transmission axis 20. In the assembled and spring-unloaded state, the clutch webs 158 are arranged in a gap 153 between the inner drive web 152A and the outer drive web 152B. The clutch webs 158 are designed such that they intersect the spring axis 154.

The drive webs 152A, 152B interact with the arc springs 142 in such a way that the arc spring 142 can be driven in rotation by means of the lower shell 138. The clutch webs 158 interact with the arc springs 142 in such a way that the upper shell 140 can be driven in rotation by means of the arc springs 142.

The arc spring clutch 102 is designed such that, when no load torque acts upon the output shaft 28 or the upper shell 140, when the lower shell 138 rotates about the transmission axis 20, no relative rotational movement or only an insignificant movement takes place between the lower shell 138 and the arc springs 142 and/or between the lower shell 138 and the upper shell 140.

The arc spring clutch 102 is further designed such that, when a load torque acts upon the output shaft 28 or the upper shell 140, a relative rotational movement takes place between the lower shell 138 and the arc springs 142 and/or between the lower shell 138 and the upper shell 140 when the lower shell 138 rotates about the transmission axis 20. In this case, the clutch webs 158 move out of the space between the drive webs 152A, 152B along the spring axis 154. The arc spring 142 is compressed.

For the transmission of force between the output shaft 28 and the jaw elements 14, a jaw toothing 160 is provided on each jaw element 14 according to FIG. 1, and cooperates with the synchronization pinion 30. The output shaft 28 and the synchronization pinion 30 can be formed in one piece or in multiple parts, and can be formed in a rotating manner. The output shaft 28 is preferably arranged perpendicular to the transmission axis 20 between the two jaw elements 14.

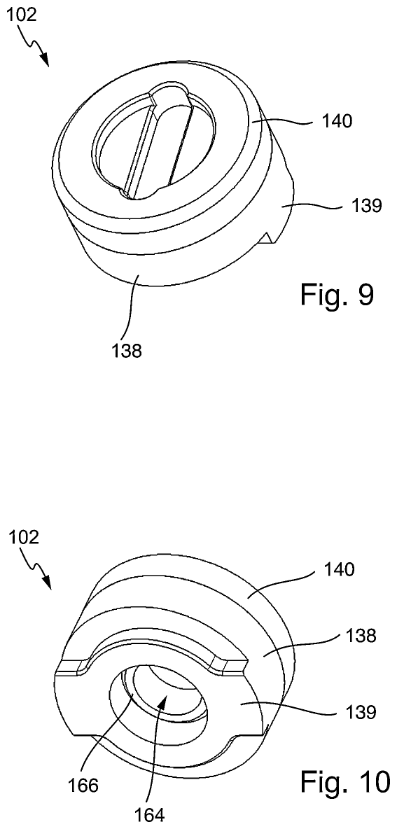

Furthermore, according to FIGS. 10 to 12, the lower shell 138 is sleeve-shaped and has a central opening 164 which, in the assembled state, receives a pin 166 that is arranged on the upper shell 140 and extends along the transmission axis 20. The pin 166 is preferably hollow, so that a transmission element of the transmission unit 18, e.g., the input shaft 22 or the output member A2, can protrude into the pin 166.

The pin 166 preferably extends 360° around the transmission axis 20. Alternatively, the pin 166 according to FIG. 12 extends by less than 320°, in particular less than 280°, preferably less than 240°, and preferably less than 220°. Accordingly, the pin 166 forms a gap 168 into which a rotary stop 170 arranged on the lower shell 138 extends. The rotary stop 170 is preferably formed integrally with the lower shell 138. It is advantageous if the rotary stop 170 in conjunction with the pin 166 further provides a sleeve-shaped recess. Such an interaction between a partially circular pin 166 and a rotary stop 170 prevents the permissible spring travel of the arc spring 142 from being exceeded or the arc spring 142 from coming to a stop. The distance in the unloaded state between the rotary stop 170 and the end of the pin 166 is preferably in a range between 30° and 70°, preferably between 40° and 60°, preferably 50°. A particularly preferred embodiment of the disclosure provides that the pin 166 extend by an angle in the range between 150° and 110°, in particular in the range between 140° and 120°, preferably 130°. Preferably, the rotary stop 170 extends by an angle in the range between 150° and 110°, in particular in the range between 140° and 120°, preferably 130°. It is advantageous if the rotary stop 170 extends by the same angle as the pin 166. Accordingly, the masses of the pin 166 and the rotary stop 170 balance one another out, so that there is no imbalance. If the pin 166 and the rotary stop 170 each extend by an angle of 130° around the transmission axis 20, the lower shell 138 and the upper shell 140 can each be rotated 50° in both directions of rotation.

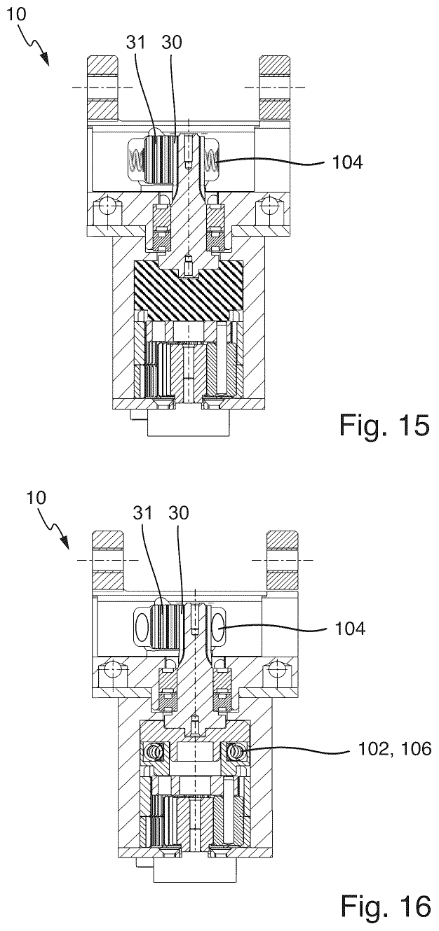

In FIGS. 13 to 16, the gripping device 10 is shown with different embodiments of the gripping force maintenance means 100. The gripping force maintenance means 100 can preferably have a translational elasticity means 104 and/or a separately designed rotational elasticity means 106. The elasticity means 104, 106 can be designed as spring means and/or elastomer means. This means that the inevitably occurring transmission and clutch play as well as system-inherent flexibility can be compensated for by means of adjustable elasticity in the drive train, thereby generating a controlled gripping force maintenance. A spring means, in particular an arc spring 102, and/or an elastomer means can be provided as the rotational elasticity means 106. A spring means and/or an elastomer means can be provided as the translational elasticity means 104. The translational elasticity means 104 and the rotational elasticity means 106 are preferably arranged at a distance from one another. Preferably, the translational elasticity means 104 is arranged in a guide assembly of the synchronization pinion 30 and/or the rack profile 31 of the jaw elements 14.

Due to the properties or a targeted design of the clastic/spring elements, kinetic energy in the drive train can be dissipated to a greater extent. This allows the gripping pulse generated during operation, which can be higher than the original gripping force, to be limited to a previously defined range. Through a targeted design of the elasticities in the system, kinetic energy is converted into spring energy. If a workpiece is lost, the elasticity (the mechanical spring) relaxes, causing the jaw elements 14 to move in the axial direction. This movement is preferably detected by a position measuring system and can be used to detect workpiece loss in the gripper control system.

In a first embodiment according to FIG. 13, the rotational elasticity means 106 is designed as an arc spring 102, and the translational elasticity means 104 is designed as a mechanical spring, in particular made of plastic or metal. Due to the combination of two adjustable, additive elasticities, the force curve can be influenced by means of two different possibilities of maintaining gripping force over a wide range. Accordingly, the adaptability and behavior of the mechatronic gripper is significantly improved. In addition, larger spring travels can be realized, which allows gripping pulse reduction and workpiece loss detection. Furthermore, by specifically adjusting the properties of the spring elements, the force curve (operating point) can be changed over a larger range.

In a second embodiment according to FIG. 14, a translational elasticity means 104 is provided in the form of an elastomer element, in particular made of plastic or metal, and no rotational elasticity means, is provided. Compared to the first embodiment, there is less possibility of adjusting the elasticity, because only an elasticity means that maintains grip force is used. This brings with it the advantages of a compact design, simplified interchangeability and assembly of the gripping force maintenance device.

In a third embodiment according to FIG. 15, a translational elasticity means 104 in the form of a mechanical spring, in particular made of plastic or metal, and no rotational elasticity means is provided. Compared to the first embodiment, there is less possibility of adjusting the elasticity, because only an elasticity means that maintains grip force is used. This has the advantage that larger spring travels can be realized, which allows gripping pulse reduction and workpiece loss detection.

In a fourth embodiment according to FIG. 16, a translational elasticity means 104 in the form of an elastomer element, in particular made of plastic or metal, and a rotational elasticity means 106 in the form of an arc spring 102 are provided. This allows the gripping pulse generated during operation, which can be higher than the original gripping force, to be limited to a previously defined range. Through a targeted design of the elasticities in the system, kinetic energy is converted into spring energy. If a workpiece is lost, the elasticity (the mechanical spring) relaxes, causing the base jaw to move in the axial direction. This movement is preferably detected by a position measuring system and can be used to detect workpiece loss in the gripper control system. Furthermore, the gripping force maintenance means 100 can be provided in a simpler manner and at a lower cost compared to the first embodiment.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed:

1. A gripping or clamping device having a base housing, having at least one jaw element arranged to be movable in the base housing, and having a transmission unit,
wherein the transmission unit has an input shaft and an output shaft, wherein the input shaft can be coupled or is coupled to a drive and wherein the output shaft can be coupled or is coupled to the at least one jaw element, and
wherein the transmission unit is designed as an inhibiting planetary transmission.

2. The gripping or clamping device according to claim 1, wherein the planetary transmission is designed as a single-stage planetary transmission and/or as a multi-stage planetary coupling transmission and/or as a reduced planetary coupling transmission and/or as a Wolfrom transmission.

3. The gripping or clamping device according to claim 1, wherein the planetary transmission has a first ring gear, a second ring gear formed separately therefrom, and at least one planetary gear, wherein the at least one planetary gear has a first planetary portion and a second planetary portion, and wherein the first planetary portion cooperates with the first ring gear, and the second planetary portion cooperates with the second ring gear.

4. The gripping or clamping device according to claim 3, wherein the first ring gear and the second ring gear have different numbers of teeth, wherein the first planetary portion and the second planetary portion have the same toothing, and wherein the first ring gear and/or the second ring gear and/or the first planetary portion and/or the second planetary portion have a profile shift.

5. The gripping or clamping device according to claim 3, wherein the first ring gear and the second ring gear have different numbers of teeth, wherein the at least one planetary gear is designed as a stepped planet, and the first planetary portion and the second planetary portion have different toothing.

6. The gripping or clamping device according to claim 3, wherein the planetary transmission further has a planet carrier in addition to the first ring gear, the second ring gear, and the at least one planetary gear, and wherein the planet carrier forms an input member, and the second ring gear forms an output member.

7. The gripping or clamping device according to claim 3, wherein the planetary transmission, in addition to the first ring gear, the second ring gear, and the at least one planetary gear, further has a sun gear and a planet carrier, and wherein the sun gear forms an input member, and the second ring gear forms an output member.

8. The gripping or clamping device according to claim 3, wherein the base housing forms and/or fixes the first ring gear.

9. The gripping or clamping device according to claim 2, wherein the planetary transmission has a first sun gear, a second sun gear formed separately therefrom, and at least one planetary gear, wherein the at least one planetary gear has a first planetary portion and a second planetary portion, wherein the first planetary portion cooperates with the first sun gear, and the second planetary portion cooperates with the second sun gear, wherein the planetary portions have the same toothing and a profile shift or a different toothing.

10. The gripping or clamping device according to claim 1,
wherein a first stage of the transmission unit is formed by a first partial transmission with a first input member and a first output member,
wherein a second stage of the planetary transmission is formed by a second partial transmission with a second input member and a second output member,
wherein the input shaft is rotationally coupled to the first input member of the first partial transmission,
wherein the first output member of the first partial transmission is rotationally coupled to the second input member of the second partial transmission, and
wherein the second output member of the second partial transmission is rotationally coupled to the output shaft.

11. The gripping or clamping device according to claim 10, wherein the first partial transmission has a first planet carrier, at least one first planetary gear, a first ring gear, and a second ring gear, wherein the second partial transmission has a second planet carrier, at least one second planetary gear, a second sun gear, and a third ring gear, wherein the first planet carrier forms the first input member, the second ring gear forms the first output member, the second sun gear forms the second input member and the third ring gear forms the second output member.

12. The gripping or clamping device according to claim 1, further comprising a gripping force maintenance means for maintaining gripping force and/or position on at least one jaw element.

13. The gripping or clamping device according to claim 12, wherein the gripping force maintenance means is designed as a spring means, in particular an arc spring clutch, and/or as a magnetic, hydraulic, or pneumatic brake and/or as a friction means and/or as a clamping means and/or as an elastomer means.

14. The gripping or clamping device according to claim 13, wherein the gripping force maintenance means has a translational elasticity means and a rotational elasticity means formed separately therefrom.

15. The gripping or clamping device according to claim 1, further comprising a position maintenance means for maintaining the position of the at least one jaw element.
